(19) United States
(12) Patent Application Publication
(10) Pub. No.: US 2016/0303784 A1
(43) Pub. Date: Oct. 20, 2016

(54) TWO MATERIAL INJECTION MOLDING APPARATUS COMPONENT AND ADDITIVE MANUFACTURING PROCESS THEREFOR

(71) Applicant: SYNVENTIVE MOLDING SOLUTIONS, INC., PEABODY, MA (US)

(72) Inventor: VITO GALATI, ROWLEY, MA (US)

(21) Appl. No.: 15/189,124

(22) Filed: Jun. 22, 2016

Related U.S. Application Data
(63) Continuation of application No. PCT/US2015/011286, filed on Jan. 14, 2015.
(60) Provisional application No. 61/927,694, filed on Jan. 15, 2014.

(51) Int. Cl. B29C 45/28; B33Y 80/00; B22F 3/105

(52) U.S. Cl. CPC B29C 45/2806; B22F 3/1055; B33Y 80/00; B29C 2045/2858; B29C 2045/2865; B33Y 10/00

(57) ABSTRACT

A valve pin in an injection molding system having an axis and comprising:
a first body portion formed into a stem that is comprised of a first selected metal material, the stem comprising an elongated shaft having an upstream end interconnected to an actuator and a downstream end,
a second body portion that is formed integrally together with the stem and is comprised of a second selected material different from the first material, the second body portion formed together with and extending distally from the downstream end of the stem into a distal-most extending tip end that is integral or unitary with the stem,
the second selected material having a substantially greater degree of resistance to corrosion or wear or abrasion than the first selected material,
the distal-most extending tip end being formed into a geometry or configuration that is complementary to a preselected geometry or configuration of a gate such that when the valve pin is moved into a gate closed position the distal-most extending tip end engages an interior surface of the gate to prevent injection fluid from flowing through the gate.

### RELATED APPLICATIONS

This application is a continuation of and claims the benefit of priority to PCT/US15/011286 filed Jan. 14, 2015 which in turn claims the benefit of priority to U.S. Provisional Application Ser. No. 61/927,694 filed Jan. 15, 2014 the disclosures of both of which are incorporated by reference in their entirety as if fully set forth herein.

This application is also a continuation-in-part of and claims the benefit of priority to PCT/US2014/047789 filed Jul. 23, 2014, which claims the benefit of priority to U.S. Ser. No. 61/857,497 filed Jul. 23, 2013 the disclosures of both of which are incorporated by reference in their entirety as if fully set forth herein.

This application is also continuation-in-part of and claims the benefit of priority to U.S. application Ser. No. 13/484,336 filed May 31, 2012 which is a continuation of PCT/US2011/062099 filed Nov. 23, 2011, the disclosures of both of the foregoing are incorporated by reference in their entirety as if fully set forth herein.

This application is also a continuation-in-part of and claims the benefit of priority to U.S. application Ser. No. 13/484,408 filed May 31, 2012 which is a continuation of PCT/US2011/062096 filed Nov. 23, 2011, the disclosures of both of the foregoing are incorporated by reference in their entirety as if fully set forth herein.

The disclosures of all of the following are incorporated by reference in their entirety as if fully set forth herein: U.S. Pat. No. 5,894,025, U.S. Pat. No. 6,062,840, U.S. Pat. No. 6,294,122, U.S. Pat. No. 6,309,208, U.S. Pat. No. 6,287,107, U.S. Pat. No. 6,343,921, U.S. Pat. No. 6,343,922, U.S. Pat. No. 6,254,377, U.S. Pat. No. 6,261,075, U.S. Pat. No. 6,361,300 (7006), U.S. Pat. No. 6,419,870, U.S. Pat. No. 6,464,909 (7031), U.S. Pat. No. 6,599,116, U.S. Pat. No. 7,234,929 (7075US1), U.S. Pat. No. 7,419,625 (7075US2), U.S. Pat. No. 7,569,169 (7075US3), U.S. patent application Ser. No. 10/214,118, filed Aug. 8, 2002 (7006), U.S. Pat. No. 7,029,268 (7077US1), U.S. Pat. No. 7,270,537 (7077US2), U.S. Pat. No. 7,597,828 (7077US3), U.S. patent application Ser. No. 09/699,856 filed Oct. 30, 2000 (7056), U.S. patent application Ser. No. 10/269,927 filed Oct. 11, 2002 (7031), U.S. application Ser. No. 09/503,832 filed Feb. 15, 2000 (7053), U.S. application Ser. No. 09/656,846 filed Sep. 7, 2000 (7060), U.S. application Ser. No. 10/006,504 filed Dec. 3, 2001, (7068) and U.S. application Ser. No. 10/101,278 filed Mar. 19, 2002 (7070).

### BACKGROUND OF THE INVENTION

Injection molding systems using components such as valve pins comprised of a stem and one or more additional components attached to the stem for sensing or other purposes have been developed. The additional components are typically separately produced by manufacturing methods such as machining, lathing, drilling and the like of blank metal components to form a desired configuration out of a larger blank metal or plastic cylinder, block or other solid object whereby metal or plastic from the initial starting blank metal or plastic cylinder, block or object is removed.

### SUMMARY OF THE INVENTION

In accordance with the invention there is provided a valve pin in an injection molding system comprised of a manifold, a mold having a cavity and flow channel communicating with the cavity via a gate to enable flow of injection fluid from the manifold through the gate into the cavity to form a part via controlled movement of the valve pin within the flow channel between a gate closed position and one or more gate open positions, the valve pin having an axis and comprising:

a first body portion formed into a stem that is comprised of a first selected metal material, the stem comprising an elongated shaft having an upstream end interconnected to the actuator and a downstream end,

a second body portion that is formed integrally together with the stem and is comprised of a second selected material different from the first material, the second body portion formed together with and extending distally from the downstream end of the stem into a distal-most extending tip end that is integral or unitary with the stem,

the second selected material having a substantially greater degree of resistance to corrosion or wear or abrasion than the first selected material,

the distal-most extending tip end being formed into a geometry or configuration that is complementary to a preselected geometry or configuration of the gate such that when the valve pin is moved into the gate closed position the distal-most extending tip end engages an interior surface of the gate to prevent injection fluid from flowing through the gate.

The first and second body portions of the valve pin are formed by sequentially layering the first and second selected materials integrally together in a predetermined sequence of layers controlled by a algorithm that includes instructions that instruct a sequential layering of the first and second materials integrally together in the predetermined sequence.

The valve pin can include a protrusion or head disposed upstream of the distal-most extending tip end, the protrusion or head having a circumferential surface with an enlarged diameter that is complementary to an inner guide surface of the flow channel which slidably engages the circumferential surface of the protrusion or head to guide downstream movement of the valve pin from an upstream gate open position along the axis toward and into the gate closed position.

The actuator can be interconnected to a controller that controls movement of the actuator at least in part according to instructions that instruct the actuator to move the valve pin continuously upstream at one or more selected intermediate velocities that are less than a maximum velocity over the course of upstream travel of the valve pin beginning from the downstream gate closed position along a selected portion or all of the upstream stroke length. The controller can include instructions that drive the actuator upstream from the gate closed position at the one or more selected intermediate velocities over a selected portion of the upstream stroke length and then subsequently drive the actuator to a fully gate open position at the maximum upstream velocity. The instructions can control actuator movement based a signal generated by a sensor that senses position of the actuator or valve pin. Alternatively, the instructions can control actuator movement based on one or more predetermined periods of elapsed time.

The actuator can comprise a fluid driven actuator or an electrically driven motor.

The distal-most extending tip 27 is typically comprised of a material selected from Carbide, Cemented Carbide, Tantalum Alloys, Zirconium Alloys, Titanium Alloys, Molybdenum Alloys, High Vanadium containing Steel and Stainless Steel.

The alloys are typically alloys of or with iron or steel.

The material of which the stem 22 is comprised preferably has a corrosion rate of between about 0 and about 4 mpy (mils per year).

The material of which the distal end 27 is comprised preferably has a corrosion rate of between about 0 and about 2 mpy.

The stem 22 is preferably comprised of a material selected from M390 (DIN4.2001), H13 (DIN1.2344), D2 (DIN1.2379) and M2 (DIN1.3343, SKH-51).

The material of which the tip 27 is comprised preferably has a substantially greater hardness relative to the hardness of the material of which the stem 22 is comprised typically greater than about 5 HRC units (Rockwell scale units). Most preferably, the material of which the tip end 27 is comprised has a hardness of greater than about 64 HRC and the material of which the stem is comprised has a hardness of less than about 59 HRC.

The material of which the tip 27 is comprised preferably has a thermal conductivity that is substantially less than the thermal conductivity of the material of which the stem 22 is comprised typically less than about 25 W/m-K units (Watt/meter-Kelvin). Most preferably, the material of which the tip end 27 is comprised has a thermal conductivity of between about 1 and about 5 W/m-K. The material of which the stem is comprised typically has a thermal conductivity of between about 25 and about 40 W/m-K. In selected applications the tip end 27 material can have a thermal conductivity of between about 60 and about 100 W/m-K.

In another aspect of the invention there is a provided a method of forming a part using the valve pin described above comprising injecting the injection fluid described above from an injection machine into the manifold of the injection molding system as described above and controlling the flow of injection fluid into the cavity of the mold via controlled movement of the valve pin as described above between the gate closed position and one or more gate open positions.

In another aspect of the invention there is provided an injection molding system comprising a valve pin, a manifold, a mold having a cavity and flow channel communicating with the cavity via a gate to enable flow of injection fluid from the manifold through the gate into the cavity to form a part via controlled movement of the valve pin within the flow channel between a gate closed position and one or more gate open positions, wherein the valve pin comprises:

a first body portion formed into a stem that is comprised of a first selected metal material, the stem comprising an elongated shaft having an upstream end interconnected to the actuator and a downstream end,

a second body portion that is formed integrally together with the stem and is comprised of a second selected material different from the first material, the second body portion being formed at the downstream end of the stem into a distal-most extending tip end that is integral or unitary with the stem,

the second selected material having a substantially greater degree of resistance to corrosion or wear or abrasion than the first selected material,

the distal-most extending tip end being formed into a geometry or configuration that is complementary to a preselected geometry or configuration of the gate such that when the valve pin is moved into the gate closed position the distal-most extending tip end mates with an interior surface of the gate to prevent injection fluid from flowing through the gate.

The first and second body portions of the valve pin are formed by sequentially layering the first and second selected materials integrally together in a predetermined sequence of layers controlled by a algorithm that includes instructions that instruct a sequential layering of the first and second materials integrally together in the predetermined sequence.

The valve pin can include a protrusion or head disposed upstream of the distal-most extending tip end, the protrusion or head having a circumferential surface with an enlarged diameter that is complementary to an inner guide surface of the flow channel which slidably engages the circumferential surface of the protrusion or head to guide downstream movement of the valve pin from an upstream gate open position along the axis toward and into the gate closed position.

The actuator can be interconnected to a controller that controls movement of the actuator at least in part according to instructions that instruct the actuator to move the valve pin continuously upstream at one or more selected intermediate velocities that are less than a maximum velocity over the course of upstream travel of the valve pin beginning from the downstream gate closed position along a selected portion or all of the upstream stroke length. The controller can include instructions that drive the actuator upstream from the gate closed position at the one or more selected intermediate velocities over a selected portion of the upstream stroke length and then subsequently drive the actuator to a fully gate open position at the maximum upstream velocity. The instructions can control actuator movement based a signal generated by a sensor that senses position of the actuator or valve pin. Alternatively, the instructions can control actuator movement based on one or more predetermined periods of elapsed time.

The actuator can comprise a fluid driven actuator or an electrically driven motor.

The distal-most extending tip 27 is typically comprised of a material selected from Carbide, Cemented Carbide, Tantalum Alloys, Zirconium Alloys, Titanium Alloys, Molybdenum Alloys, High Vanadium containing Steel and Stainless Steel.

The alloys are typically alloys of or with iron or steel.

The material of which the stem 22 is comprised preferably has a corrosion rate of between about 0 and about 4 mpy (mils per year).

The material of which the distal end 27 is comprised preferably has a corrosion rate of between about 0 and about 2 mpy.

The stem 22 is preferably comprised of a material selected from M390 (DIN4.2001), H13 (DIN1.2344), D2 (DIN1.2379) and M2 (DIN1.3343, SKH-51).

The material of which the tip 27 is comprised preferably has a substantially greater hardness relative to the hardness of the material of which the stem 22 is comprised typically greater than about 5 HRC units (Rockwell scale units). Most preferably, the material of which the tip end 27 is comprised has a hardness of greater than about 64 HRC and the material of which the stem is comprised has a hardness of less than about 59 HRC.

The material of which the tip 27 is comprised preferably has a thermal conductivity that is substantially less than the thermal conductivity of the material of which the stem 22 is comprised typically less than about 5 W/m-K units (Watt/meter-Kelvin). Most preferably, the material of which the tip end 27 is comprised has a thermal conductivity of between about 1 and about 5 W/m-K. The material of which the stem is comprised typically has a thermal conductivity of between about 25 and about 40 W/m-K. In selected applications the tip end 27 material can have a thermal conductivity of between about 60 and about 100 W/m-K.

In another aspect of the invention there is a provided a method of forming a part using the injection molding system described above comprising injecting the injection fluid described above from an injection machine into the manifold of the injection molding system as described above and controlling the flow of injection fluid into the cavity of the mold via controlled movement of the valve pin as described above between the gate closed position and one or more gate open positions.

In another aspect of the invention there is provided a valve pin for controlling flow through a gate in an injection molding system that is comprised of a manifold, a mold having a cavity and a flow channel communicating with the cavity via the gate to enable flow of injection fluid from the manifold through the gate into the cavity to form a part via controlled movement of the valve pin within the flow channel between a gate closed position and one or more gate open positions,

wherein the valve pin comprises:

a first body portion formed into a stem that is comprised of a first selected metal material, the stem comprising an elongated shaft having an upstream end interconnected to the actuator and a downstream end,

a second body portion that is formed integrally together with the stem and is comprised of a second selected material different from the first material, the second body portion being formed at the downstream end of the stem into a distal-most extending tip end that is integral or unitary with the stem,

the second selected material having a substantially greater degree of resistance to corrosion or wear or abrasion than the first selected material,

wherein the first and second body portions of the valve pin are formed by sequentially layering the first and second selected materials integrally together in a predetermined sequence of layers via a three dimensional printing process that is controlled by an algorithm that includes instructions that instruct a sequential layering of the first and second selected materials integrally together in the predetermined sequence.

The invention also provides a method of forming a part using the valve pin described comprising injecting the injection fluid described above from an injection machine into the manifold of the injection molding system described above and controlling the flow of injection fluid into the cavity of the mold via controlled movement of the valve pin between the gate closed position and one or more gate open positions.

In another aspect of the invention there is provided a method of manufacturing via an additive manufacturing process an injection molding apparatus that is comprised of at least two different or separate materials. The additive process results in a single unitary metal or polymeric object or body having a preselected configuration where preselected portions of the volume or geometry of the single unitary object or body that is formed are comprised of separate or different materials.

A single unitary object or body means an object or body that is not comprised of two pieces or parts that are first separately formed and then subsequently attached or adhered to each other via mechanical or chemical or other means, but is rather a unitary object or body that is inherently cohesive, unitary or integral in material structure such that the unitary object or body cannot be mechanically or chemically disassembled into separate parts or pieces. A unitary object or body is preferably formed by a sequentially depositing one layer of metal material on top of another and continuing such a sequential layering process to form a single unitary body or object comprised of an accumulation of the sequentially deposited layers of metal material.

A unitary metal object or body of the invention and its discrete separate portions are formed by a metal additive process that is computer or software controlled to deposit layers of metal material successively one on top of each other in a three-dimensional arrangement that results ultimately in the formation of a valve pin having at least two separate portions comprised of separate materials. The successive layers are deposited one on top of each other bound to each other either by including a binder material integral with the metal material or by including a binder material as a layer between successive layers of the metal materials. Such layering processes can be carried out using one or more of a robocasting process, an electron beam freeform fabrication process, a direct metal laser sintering process, an electron beam melting process, a selective laser melting process, a selective heat sintering process or a selective laser sintering process.

A digital model of the unitary valve pin body comprised of at least two separate materials can be created with a computer aided design (CAD) package or via a 3D scanner or via a plain digital camera and photogrammetry software. Where a 3D scanning or digital camera process is used, the 3D scan or digital photograph can be first taken of a non-unitary, two-piece valve pin to generate a digital data image of the shape and appearance of the two-piece object and based on this image data, a modified three-dimensional model of a unitary valve pin body can then be produced and used as the basis for the layer printing machine carrying out the layering process.

In another aspect of the invention there is provided a method of forming, creating or manufacturing via an additive manufacturing process such as a 3D printing or a sequential layering process a unitary valve pin composite body for use in an injection molding apparatus wherein the valve pin composite body is comprised of a unitary metal or polymeric material, a portion of which comprises a stem removably interconnected to an actuator and another integral or unitary portion of which comprises a distal end member or portion formed integrally together with the stem into and as the unitary valve pin composite body, the distal end member being formed or configured as and at a downstream distal tip end of the stem,

the stem and end member being controllably drivable along an axial path of travel through a fluid delivery channel of a nozzle via controllable axial upstream-downstream drive of the actuator,

the distal end member portion being formed into a configuration that is complementary to a predetermined configuration of a gate such that the distal end member portion is receivable within the gate to mate with interior surfaces of the gate to close off the gate to stop fluid flow through the gate on controlled downstream driving of the valve pin and distal end piece,

the distal end member portion being comprised of a first selected metal material and the stem being comprised of a second selected metal material that is different in composition from the first selected material.

The first selected material is typically selected to be a corrosion resistant or abrasion or wear resistant material.

The distal end member is typically selected to be printed, formed and comprised of a material selected from Carbide, Cemented Carbide, Tantalum Alloys, Zirconium Alloys, Titanium Alloys, Molybdenum Alloys, High Vanadium containing Steel and Stainless Steel.

The alloys are typically alloys of or with iron or steel.

The material of which the stem is comprised preferably has a corrosion rate of between about 0 and about 4 mpy (mils per year).

The material of which the distal end member is printed, formed and comprised preferably has a corrosion rate of between about 0 and about 2 mpy.

The stem is preferably printed, formed and comprised of a material selected from M390 (DIN4.2001), H13 (DIN1.2344), D2 (DIN1.2379) and M2 (DIN1.3343, SKH-51).

The material of which the distal end member is printed, formed and comprised typically has a substantially greater degree of resistance to corrosion or wear or abrasion than the degree of resistance of the material of which the stem is printed and comprised to corrosion or wear or abrasion.

The material of which the tip 27 is comprised preferably has a substantially greater hardness relative to the hardness of the material of which the stem 22 is comprised typically greater than about 5 HRC units (Rockwell scale units). Most preferably, the material of which the tip end 27 is comprised has a hardness of greater than about 64 HRC and the material of which the stem is comprised has a hardness of less than about 59 HRC.

The material of which the tip 27 is comprised preferably has a thermal conductivity that is substantially less than the thermal conductivity of the material of which the stem 22 is comprised typically less than about 5 W/m-K units (Watt/meter-Kelvin). Most preferably, the material of which the tip end 27 is comprised has a thermal conductivity of between about 1 and about 5 W/m-K. The material of which the stem is comprised typically has a thermal conductivity of between about 25 and about 40 W/m-K. In selected applications the tip end 27 material can have a thermal conductivity of between about 60 and about 100 W/m-K.

The injection molding apparatus described above is typically comprised of an actuator mounted to either a top clamp plate or fluid distribution manifold that has fluid distribution channels that receive injection fluid material from the injection molding machine, at least one of the fluid distribution channels communicating with a nozzle having a nozzle fluid delivery channel that communicates with a distal downstream gate having a predetermined configuration, the injection molding apparatus including a mold having a cavity that communicates with the downstream gate to enable the injection fluid to flow under pressure into the cavity.

### BRIEF DESCRIPTION OF THE DRAWINGS

The above and further advantages of the invention may be better understood by referring to the following description in conjunction with the accompanying drawings in which:

FIG. 1 is a cross-section of an embodiment of the invention showing a unitary valve pin 20 in an injection molding system stack showing the valve pin 20 mounted within the system and the relative arrangement of components of the system.

FIG. 2 is a close-up cross-section of the FIG. 1 system showing in greater detail the relative size, configuration and arrangement of the two portions 22 and 27 of which the unitary valve pin body 20 is comprised.

FIG. 3A is a cross-sectional view of a two material valve pin according to the invention where the pin is in a gate closed position and the configuration of the pin is cylindrical along essentially its entire shaft and tip end length.

FIG. 3B is a view of the FIG. 3A embodiment showing the pin disposed in an intermediate upstream position where the flow of injection fluid through the gate is restricted via a restriction gap to a rate that is less than the maximum rate of flow that the system will allow.

### DETAILED DESCRIPTION

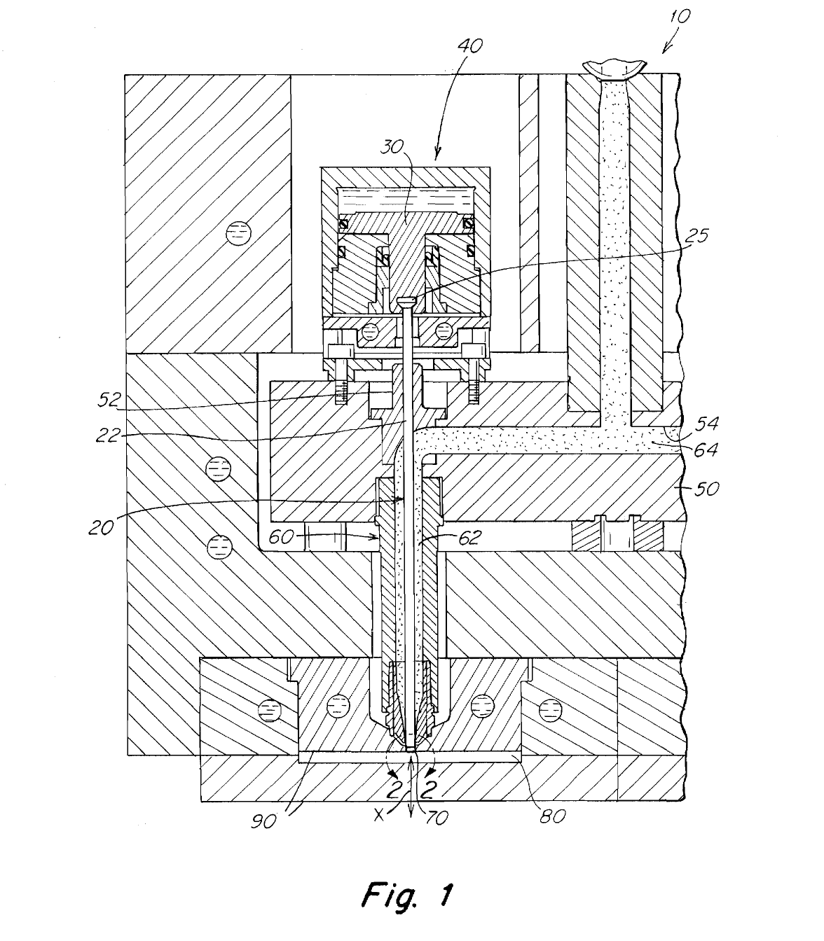

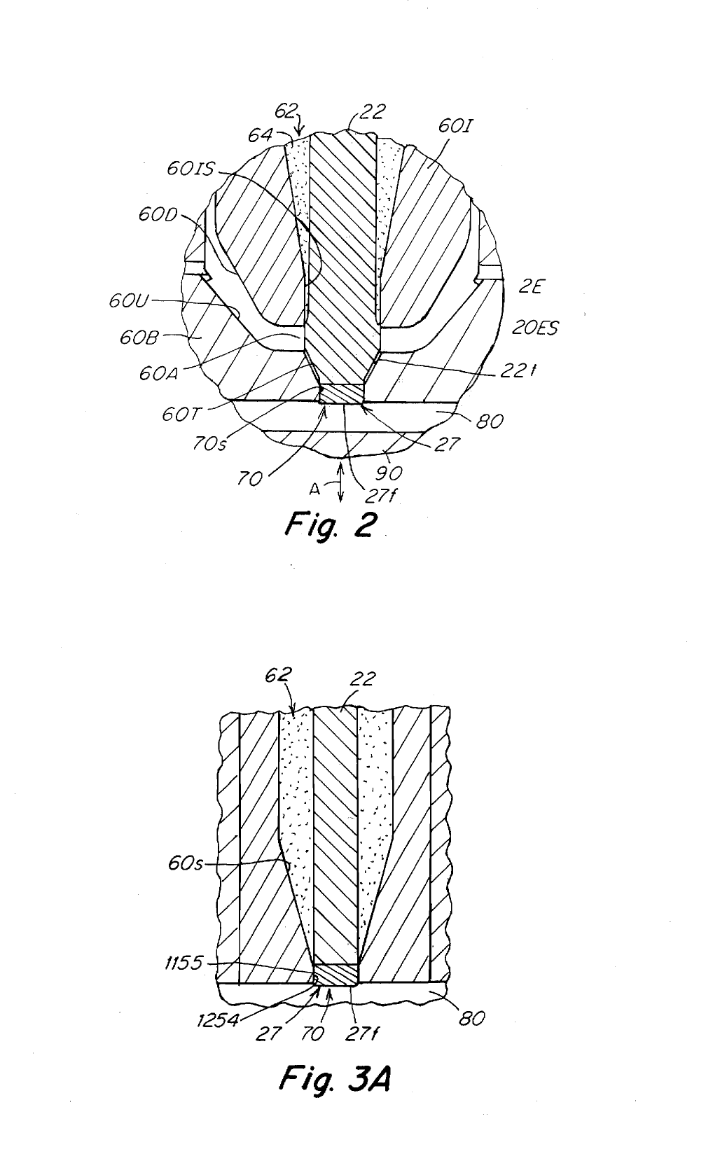

FIGS. 1, 2 shows one embodiment of the invention where a valve in the system 10 has a valve pin 20, the upstream head 25 of which is mounted within a mounting, receiving slot of the piston 30 of an actuator 40 which is mounted to a fluid distribution manifold or hotrunner 50. As shown the valve pin 20 is comprised of an elongated stem 22 that is slidably mounted in a complementary aperture in a bushing 52 that is attached to the manifold 50 in an arrangement that disposes the stem 22 to extend through a fluid distribution channel 54 of the manifold and further downstream through the fluid distribution channel 62 of a nozzle 60. The piston 30 is controllably driven in an upstream-downstream axial X manner which in turn controllably drives the valve stem 22 in and along the same upstream-downstream direction and motion X. The distal tip end 27 of the valve pin stem 22 is in turn driven axially X back and forth between a closed gate position as shown in FIG. 2 and an upstream gate open position. In the gate closed position of FIG. 2, the tip end 27 closes off the gate aperture 70 that communicates with the mold cavity 80 contained within the mold 90 plates. When the stem 22 and tip end 27 are moved upstream to an upstream gate open position the gate aperture 70 is no longer blocked from communication with cavity 80 and injection fluid material 64 that is injected under pressure from channel 54 into nozzle channel 62 can then flow past the outer surface of tip end 27 and the inner surface 70s of gate 70 through gate aperture 70 into cavity 80.

In the embodiment shown in FIGS. 1, 2 the valve pin 20 comprises single unitary body or object 20 having an enlarged distal portion, protrusion or head 20E that has an outer circumferential surface 20ES that has a widened or enlarged diameter and a configuration that is complementary to the radially interior surface 601S of a nozzle insert 601 which acts as a guide surface for guiding the travel of the pin 20 along its axis A from an upstream position toward and into a downstream gate closed position as shown in FIG. 2. In the FIG. 2 embodiment, a fluid sealed air gap 60A is provided between the downstream undersurface 60D of the insert 601 and the upstream facing surface 60U of the nozzle body 60B. The air gap 60A is disposed immediately upstream of the gate 70 such that when the tip end 27 of the pin 20 travels from an upstream position downstream into the gate closed position shown in FIG. 2, injection fluid that is forced due to very high pressure backwardly upstream around the circumferential surface of the tip end 27 and the widened portion 20E can seep into the air gap 60A to relieve overly excessive pressure in the injection fluid 64 that is being forced by the downward travel of the tip end 27 into the cavity 80 at and around the gate area 70, 70s. Such enablement of back upstream flow of injection fluid and pressure relief can serve to reduce the occurrence of a vestige or flaw or unevenness in density of injection fluid within the cavity in and around the immediate area of the gate 70. In the FIG. 2 example, the outside surface 22t of the distal end portion 20E of the pin 20 that the tip end 27 is attached to is tapered and mates with a complementary interior surface 60T of the nozzle body 60B which further provides a space and a surface 60T immediately upstream of the gate 27 along which injection fluid being forced downstream into the gate 70 and cavity 80 can flow back upstream under the very high pressure environment as the pin 20 moves from an upstream position downstream toward and into the gate closed position shown in FIG. 2. Such enablement of back upstream flow of injection fluid can serve to reduce the occurrence of a vestige or flaw or unevenness in density of injection fluid within the cavity in and around the immediate area of the gate 70.

As shown in FIGS. 1-3B, the pin 20 is comprised of at least two portions 22, 27 that are separately comprised of materials of two different metal, plastic or other material compositions. The valve stem 22 and a downstream distal tip end member portion 27 are formed together as a result of an additive layering or material deposition process into a single unitary or integral body 20 during the course of the additive manufacturing process as described herein.

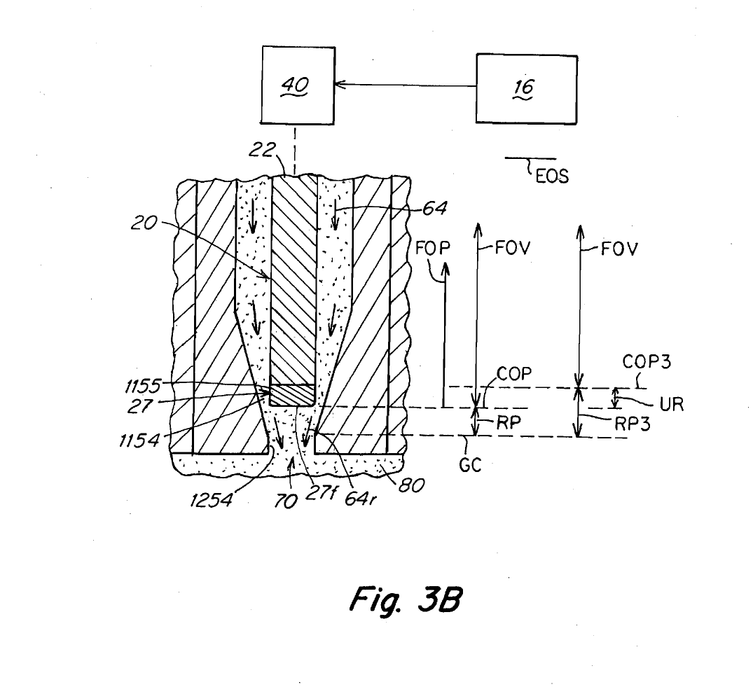

As shown in FIGS. 3A, 3B, when the stem 22 and tip end 27 are moved upstream to an upstream gate open position such as shown in FIGS. 3A, 3B the gate aperture 70 is no longer blocked from communication with cavity 80 and injection fluid material 64 that is injected under pressure from channel 54 into nozzle channel 62 can then flow past the outer surface of tip end 27 and the inner surface 70s of gate 70 through gate aperture 70 into cavity 80.

Preferably, the shape and exterior contour of the tip end 27 and valve pin and the contour of the interior gate surface 70s, 1254 are configured or adapted to cooperate with each other to restrict and vary the rate of flow 64r of fluid material 1153, FIGS. 3A, 3B over the course of travel of the tip end of the valve pin 20 through the restricted velocity path RP. Typically the outside surfaces 1155 of the tip end 27 of the pin 20 create restricted flow channels such as channel 1154 that reduce the volume or rate of flow of fluid material relative to the rate of flow when the pin is at a full gate open position COP3 when it is at or beyond, for example the 4 mm upstream position COP. As the tip end 27 of the pin 20 continues to travel upstream from the gate closed position shown for example in FIGS. 2, 3A through the selected length of the RP path, the rate of fluid flow into the cavity continues to increase from 0 to a maximum when the tip end 27 of the pin 20 reaches the gate fully open position of, for example the 4 mm position, COP. As shown in the FIGS. 3A, 3B embodiment, the tip end 27 of the pin is cylindrical. In the FIG. 2 example, the outside surface 22t of the distal end portion 20E of the pin 20 that the tip end 27 is attached to is tapered and mates with a complementary interior surface 60T of the nozzle body 60B.

The interior surface 60T of the distal portion of the nozzle channel 62 leading to the gate 70 of the cavity 80 can be tapered to accommodate mating with the tapered distal end 22t of the pin 20 shown in the FIGS. 1, 2 configuration-embodiment pin when the pin 20 is moved to its furthest downstream gate closed position as shown in FIG. 2. The exterior circumferential surface 1155 of the tip end 27 of the pin 22 can be cylindrical as shown in FIGS. 1, 2, 3A, 3B but can also have another selected geometry or configuration and accomplish the same or a similar closure of the gate 70 and restricted flow channels 1154 for purposes of reducing or stopping the fluid material flow as described above.

With reference to FIGS. 3A, 3B, the pin 20 can be driven in a controlled manner such that the tip end 27 of the pin is withdrawn upstream beginning from the gate closed position, FIG. 2, 3A at a reduced velocity relative to a maximum velocity over either a preselected period of time as described in detail in PCT Published Application WO2012/087491 A1 or over a preselected length of pin travel RP, RP3, UR as described in detail in PCT Published Application WO2012/087491 A1, the disclosures of both of which are incorporated herein by reference in their entirety as if fully set forth.

In one aspect of the invention beginning from the gate closed position of FIG. 3A, as the tip end 27 of the pin 20 travels upstream from the gate closed position through the length of the RP path (namely the path travelled for either a predetermined amount of time or a predetermined length), the rate of material fluid flow 64r through restriction gap 1154 through the gate 70 into the cavity 80 continues to increase from 0 at gate closed position to a maximum flow rate when the tip end 27 of the pin reaches a position FOP (full open position) or COP3 where the pin tip 27 is no longer restricting flow of injection mold material through the gate 70. In such an embodiment, at the expiration of either the predetermined amount of time or the predetermined length of upstream travel, the pin 22 is immediately driven upstream by the actuator at maximum velocity FOV (full open velocity).

In alternative embodiments, when either the predetermined time or predetermined length of travel for driving the pin at reduced velocity has expired and the tip 27 has reached the end of restricted flow path RP, the tip 27 may not necessarily be in a position where the fluid flow 64r is not still being restricted. In such alternative embodiments, the fluid flow 64r can still be restricted to less than maximum flow when the pin has reached the changeover position where the pin 22 is driven at a higher, typically maximum, upstream velocity FOV. In the examples shown in FIGS. 3A, 3B when the pin 20 has travelled the predetermined path length at reduced velocity and the tip end 27 has reached the changeover point COP, the tip end 27 of the pin 20 (and its radial surface 1155) no longer restricts the rate of flow of fluid material 64 through the gap 1154 because the gap 1154 has increased to a size that no longer restricts fluid flow 64 below the maximum flow rate of material flow. Thus in the FIG. 3B example, the maximum fluid flow rate for injection material is reached at the upstream position COP of the tip end 27.

In another alternative embodiment, shown in FIG. 3B, the pin 20 can be driven and instructed to be driven at reduced or less than maximum velocity over a longer path length RP3 having an upstream portion UR where the flow of injection fluid mold material is not restricted but flows at a maximum rate through the gate 70 for the given injection mold system. In this FIG. 3B example the velocity or drive rate of the pin 20 is not changed over until the tip end 27 of the pin 20 or actuator has reached the changeover position COP3. As in other embodiments, a position sensor can be used to sense either that the valve pin 22 or an associated component has travelled the path length RP3 or reached the end COP3 of the selected path length and a controller receives and processes such information and instructs the drive system to drive the pin 20 at a higher, typically maximum velocity upstream. In another alternative embodiment, the pin 20 can be driven at reduced or less than maximum velocity throughout the entirety of the travel path of the pin during an injection cycle from the gate closed position up to the end-of-stroke EOS position, the controller 16 being programmed to instruct the drive system for the actuator 40 to be driven at one or more reduced velocities for the time or path length of an entire gate closed to fully open EOS cycle.

Preferably the tip 27 portion is comprised of a material that has a thermal conductivity that is substantially less than the thermal conductivity of the material of which stem 22 portion is comprised.

Preferably the tip 27 portion is comprised of a material that has a hardness that is substantially greater than the hardness of the material of which stem 22 portion is comprised.

The material of which the tip 27 is comprised preferably has a substantially greater hardness relative to the hardness of the material of which the stem 22 is comprised typically greater than about 5 HRC units (Rockwell scale units). Most preferably, the material of which the tip end 27 is comprised has a hardness of greater than about 64 HRC and the material of which the stem is comprised has a hardness of less than about 59 HRC.

The material of which the tip 27 is comprised preferably has a thermal conductivity that is substantially less than the thermal conductivity of the material of which the stem 22 is comprised typically less than about 5 W/m-K units (Watt/meter-Kelvin). Most preferably, the material of which the tip end 27 is comprised has a thermal conductivity of between about 1 and about 5 W/m-K. The material of which the stem is comprised typically has a thermal conductivity of between about 25 and about 40 W/m-K. In selected applications the tip end 27 material can have a thermal conductivity of between about 60 and about 100 W/m-K.

Most preferably the tip 27 portion is comprised of a material that is corrosion resistant or wear or abrasion resistant or both to prevent or retard corrosion or wear or abrasion at least at the face surface 27f of the tip end piece 27.

Most preferably, the hardness of the stem 22 portion of the unitary body 20 is between about 45 and about 65 HRC. The hardness of the material of which valve pin tip 27 portion is comprised is typically between about 40 and about 100 HRC (which is limited by the degree of wear/mechanical strength desirable for shutting the gate closed on the low end for corrosion resistant materials).

Preferably, the corrosion rate of the material of which the stem 22 portion of the body 20 is comprised is between about 0 and about 4 mpy (mils per year).

Preferably, the corrosion rate of the material of which the tip 27 portion is comprised is between about 0 and about 2 mpy.

Preferably the materials of which the stem 22 portion is comprised are selected from materials such as M390 (DIN4.2001), H13 (DIN1.2344), D2 (DIN1.2379) and M2 (DIN1.3343, SKH-51).

Preferably the materials of which the tip 27 portion is comprised are selected from materials such as Carbide, Cemented Carbide, Tantalum (Alloys), Zirconium (Alloys), Titanium (Alloys), Molybdenum (Alloys) and High Vanadium Steel, Stainless Steel Grades.

The valve pin body 20 of the injection molding apparatus is preferably manufactured and formed via an additive manufacturing or 3D printing process which is a process of making a three-dimensional solid object of virtually any shape from a digital model. 3D printing is achieved using an additive process, where successive layers of material are laid down in different shapes. 3D printing is distinct from traditional machining techniques, which mostly rely on the removal of material by methods such as cutting or drilling (subtractive processes). A 3D printer is a limited type of industrial robot that is capable of carrying out an additive process under computer control. The first working 3D printer was created in 1984 by Chuck Hull of 3D Systems Corp.

Modeling: Additive manufacturing can take virtual models (3D blueprints) from computer aided design (CAD) or animation modeling software and can “slice” them into digital cross-sections for the machine to successively use as a guideline for printing. Depending on the machine used, material or a binding material is deposited on the build bed or platform until material/binder layering is complete and the final 3D model has been “printed.”

A standard data interface between CAD software and the printing machines is the STL file format. An STL file approximates the shape of a part or assembly using triangular facets. Smaller facets produce a higher quality surface. PLY is a scanner generated input file format, and VRML (or WRL) files are often used.

Printing. To perform a print, the machine typically reads the design from an stl file and lays down successive layers of liquid, powder, paper or sheet material to build the model from a series of cross sections. These layers, which correspond to the virtual cross sections from the CAD model, are joined or automatically fused to create the final shape. This technique can thus create almost any shape or geometric feature as a unitary or integral body or object.

Printer resolution describes layer thickness and X-Y resolution in dpi (dots per inch) or micrometers. Typical layer thickness is around 100 μm (250 DPI), although some machines such as the Objet Connex series and 3D Systems' ProJet series can print layers as thin as 16 μm (1,600 DPI). X-Y resolution is comparable to that of laser printers. The particles (3D dots) are around 50 to 100 μm (510 to 250 DPI) in diameter. Construction of a model with contemporary methods can take anywhere from several hours to several days, depending on the method used and the size and complexity of the model.

Finishing: Though the printer-produced resolution is sufficient for many applications, printing a slightly oversized version of the desired object in standard resolution and then removing material with a higher-resolution subtractive process can in some cases achieve greater precision.

Some additive manufacturing techniques are capable of using multiple materials in the course of constructing parts. Some also utilize supports when building. Supports are removable or dissolvable upon completion of the print, and are used to support overhanging features during construction.

Additive processes: A large number of additive processes are now available. They differ in the way layers are deposited to create parts and in the materials that can be used. Some methods melt or soften material to produce the layers, e.g. selective laser melting (SLM) or direct metal laser sintering (DMLS), selective laser sintering (SLS), fused deposition modeling (FDM), while others cure liquid materials using different sophisticated technologies, e.g. stereo-lithography (SLA). With laminated object manufacturing (LOM), thin layers are cut to shape and joined together (e.g. paper, polymer, metal).

What is claimed is:

1. An injection molding system comprising a valve pin, a manifold, a mold having a cavity and flow channel communicating with the cavity via a gate to enable flow of injection fluid from the manifold through the gate into the cavity to form a part via controlled movement of the valve pin within the flow channel between a gate closed position and one or more gate open positions,
wherein the valve pin comprises:
a first body portion formed into a stem that is comprised of a first selected metal material, the stem comprising an elongated shaft having an upstream end interconnected to the actuator and a downstream end,
a second body portion that is formed integrally together with the stem and is comprised of a second selected material different from the first material, the second body portion being formed at the downstream end of the stem into a distal-most extending tip end that is integral or unitary with the stem,
the second selected material having a substantially greater degree of resistance to corrosion or wear or abrasion than the first selected material,
the distal-most extending tip end being formed into a geometry or configuration that is complementary to a preselected geometry or configuration of the gate such that when the valve pin is moved into the gate closed position the distal-most extending tip end mates with an interior surface of the gate to prevent injection fluid from flowing through the gate.

2. The apparatus of claim 1 wherein the first and second body portions of the valve pin are formed by sequentially layering the first and second selected materials integrally together in a predetermined sequence of layers controlled by an algorithm that includes instructions that instruct a sequential layering of the first and second materials integrally together in the predetermined sequence.

3. The apparatus of claim 1 wherein the valve pin includes a protrusion disposed upstream of the distal-most extending tip end, the protrusion having a circumferential surface with an enlarged diameter that is complementary to an inner guide surface of the flow channel which slidably engages the circumferential surface of the protrusion or head to guide downstream movement of the valve pin from an upstream gate open position along the axis toward and into the gate closed position.

4. The apparatus of claim 1 wherein the actuator is interconnected to a controller that controls movement of the actuator at least in part according to instructions that instruct the actuator to move the valve pin continuously upstream at one or more selected intermediate velocities that are less than a maximum velocity over the course of upstream travel of the valve pin beginning from the downstream gate closed position along a selected portion or all of the upstream stroke length.

5. The apparatus of claim 4 wherein the controller includes instructions that drive the actuator upstream from the gate closed position at the one or more selected intermediate velocities over a selected portion of the upstream stroke length and then subsequently drive the actuator to a fully gate open position at the maximum upstream velocity.

6. The apparatus of claim 4 wherein the instructions control actuator movement based on a signal generated by a sensor that senses position of the actuator or valve pin or based on one or more predetermined periods of elapsed time.

7. The apparatus of claim 1 wherein the actuator comprise a fluid driven actuator or an electrically driven motor.

8. The apparatus of claim 1 wherein the distal-most extending tip is comprised of a material selected from the group of Carbide, Cemented Carbide, Tantalum Alloys, Zirconium Alloys, Titanium Alloys, Molybdenum Alloys, High Vanadium containing Steel and Stainless Steel.

9. The apparatus of claim 8 wherein the alloys are alloys of or with iron or steel.

10. The apparatus of claim 1 wherein the first selected material has a corrosion rate of between about 0 and about 4 mpy.

11. The apparatus of claim 1 wherein the second selected material has a corrosion rate of between about 0 and about 2 mpy.

12. The apparatus of claim 1 wherein the first selected material is selected from the group of M390 (DIN4.2001), H13 (DIN1.2344), D2 (DIN1.2379) and M2 (DIN1.3343, SKH-51).

13. The apparatus of claim 1 wherein the second selected material has a hardness that is greater than the hardness of the first selected material by about 5 HRC units.

14. The apparatus of claim 1 wherein the hardness of the first selected material is less than about 59 HRC units and the hardness of the second selected material is greater than about 64 HRC.

15. The apparatus of claim 1 wherein the second selected material has a thermal conductivity that is less than the thermal conductivity of the material of the first selected material by about about 5 W/m-K units (Watt/meter-Kelvin).

16. The apparatus of claim 1 wherein the second selected material has a thermal conductivity of between about 1 and about 5 W/m-K and the thermal conductivity of the first selected material is between about 25 and about 40 W/m-K.

17. A method of forming a part using the injection molding system of claim 1 comprising injecting the injection fluid described above from an injection machine into the manifold of the injection molding system of claim 1 and controlling the flow of injection fluid into the cavity of the mold via controlled movement of the valve pin between the gate closed position and one or more gate open positions.

18. A valve pin for controlling flow through a gate in an injection molding system that is comprised of a manifold, a mold having a cavity and a flow channel communicating with the cavity via the gate to enable flow of injection fluid from the manifold through the gate into the cavity to form a part via controlled movement of the valve pin within the flow channel between a gate closed position and one or more gate open positions,
wherein the valve pin comprises:
a first body portion formed into a stem that is comprised of a first selected metal material, the stem comprising an elongated shaft having an upstream end interconnected to the actuator and a downstream end,
a second body portion that is formed integrally together with the stem and is comprised of a second selected material different from the first material, the second body portion being formed at the downstream end of the stem into a distal-most extending tip end that is integral or unitary with the stem,
the second selected material having a substantially greater degree of resistance to corrosion or wear or abrasion than the first selected material,
wherein the first and second body portions of the valve pin are formed by sequentially layering the first and second selected materials integrally together in a predetermined sequence of layers via a three dimensional printing process that is controlled by an algorithm that includes instructions that instruct a sequential layering of the first and second selected materials integrally together in the predetermined sequence.

19. A method of forming a part using the valve pin of claim 18 comprising injecting the injection fluid described above from an injection machine into the manifold of the injection molding system of claim 18 and controlling the flow of injection fluid into the cavity of the mold via controlled movement of the valve pin between the gate closed position and one or more gate open positions.
